(19) United States
(12) Patent Application Publication
(10) Pub. No.: US 2015/0249419 A1
(43) Pub. Date: Sep. 3, 2015

(54) SYSTEM AND METHOD FOR CONTROLLING INVERTER

(71) Applicants: Hyundai Motor Company, Seoul (KR); Kia Motors Corporation, Seoul (KR)

(72) Inventors: Joon Yong Lee, Seoul (KR); Soon Woo Kwon, Yongin (KR); Dong Hun Lee, Anyang (KR); Sung Do Kim, Seongnam (KR)

(73) Assignees: KIA MOTORS CORPORATION; HYUNDAI MOTOR COMPANY

(21) Appl. No.: 14/563,946

(22) Filed: Dec. 8, 2014

(30) Foreign Application Priority Data
Feb. 28, 2014 (KR) 10-2014-0023770

(51) Int. Cl. H02P 23/10

(52) U.S. Cl. CPC H02P 23/10

(57) ABSTRACT

A method and system for controlling an inverter for operating a motor are provided. The method includes reducing a switching frequency of the inverter for applying a load current to the motor when the motor is used for energy consumption. Reduction of the switching frequency of the inverter enhances damage prevention and durability of the inverter. In the method, an operation mode of the inverter for operating the motor is determined based on a command received from an upper-level controller. When the operation mode of the inverter is determined to be an energy consumption mode, a switching frequency of the inverter is decreased relative to the switching frequency in a general operation mode.

### CROSS-REFERENCE TO RELATED APPLICATION(S)

Pursuant to 35 U.S.C. §119(a), this application claims priority to Korean Patent Application No. 10-2014-0023770, filed Feb. 28, 2014, the entire contents of which are incorporated herein by reference.

### BACKGROUND

1. Technical Field

The present invention relates to a system and method for controlling an inverter to operate a motor. More particularly, the present invention relates to a method for controlling an inverter to operate a motor, which prevents damage and improves durability of the inverter by applying a direct current (DC) current to a stator of the motor when the motor is used for energy consumption.

2. Background Art

An environmentally friendly vehicle such as a fuel cell electric vehicle uses an inverter to operate a three-phase motor disposed within the vehicle. When the three-phase motor is used for energy consumption, the inverter allows a substantial amount of DC current to flow in a stator of the motor. In this state, the flow of the DC current may be prevented from flowing in the direction that the motor is not driven in, by operating switching elements (e.g., insulated gate bipolar transistors (IGBTs)) included in the inverter, to prevent driving of the motor.

FIG. 1 illustrates an example of the flow of a DC current (arrows) through a conventional inverter used for operating a motor. As shown in FIG. 1, current supplied from a DC power source 1 flows relatively concentratedly on a predetermined switching element (e.g., an IGBT) among switching elements in the inverter by operating the inverter 2 to prevent driving of the motor 3.

As a load is concentrated on the predetermined switching element in the inverter 2, the junction temperature of the predetermined switching element increases rapidly. Accordingly, the inverter 2 may be damaged, or the durability of the inverter 2 may decrease due to accumulated thermal fatigue or due to thermal impact. In addition, since the junction temperature of the switching element increases rapidly, a substantial amount of current may not be applied to a stator of the motor.

Generally, a switching element such as an IGBT may be used up to a junction temperature of about 150° C., and damage to the switching element may occur at a temperature greater than such a junction temperature. The durability of the switching element may be guaranteed up to a junction temperature of about 120° C.

### SUMMARY

The present invention provides a method for controlling an inverter to operate a motor (e.g. a three-phase motor), in which an inverter switching frequency for applying a load current to the motor when the motor is used for energy consumption is decreased, to prevent damage and improve durability of the inverter.

According to an exemplary embodiment, the present invention provides a method for controlling an inverter to operate a motor, the method may include: determining, by a controller, an operation mode of the inverter based on a command received from an upper-level controller; and decreasing, by the controller, a switching frequency of the inverter to be less than a frequency of the inverter in a general operation mode, when the operation mode of the inverter is determined, by the controller, to be an energy consumption mode.

The method may further include: converting, by the controller, the operation mode of the inverter into the energy consumption mode of applying a load current to the motor while maintaining the motor in a non-driven state, in response to the switching frequency of the inverter being decreased. Additionally, the method may include: operating by the controller, the inverter to output the load current to the motor until the upper-level controller receives an end signal, in response to operation mode of the inverter being converted to the energy consumption mode.

In still another exemplary embodiment of the present invention, the method may include: determining, by the controller, whether an abnormality occurs by determining whether the motor is driven, determining whether an over-current of a certain value or greater flows in the motor, and determining whether the junction temperature of the inverter has increased to at least an over-temperature of a predetermined in response to the inverter operating in the energy consumption mode. The method may further include: stopping, by the controller, the inverter from outputting the load current, in response to an abnormality occurring in the operation of the inverter in the energy consumption mode; and converting, by the controller, the operation mode of the inverter into the general operation mode, in response to an abnormality occurring in the operation of the inverter in the energy consumption mode. The method may yet further include: stopping, by the controller, the inverter from outputting the load current in response the upper-level controller receiving the end signal in the operation of the inverter in the energy consumption mode, and converting, by the controller, the operation mode of the inverter into the general operation mode, in response the upper-level controller receiving the end signal in the operation of the inverter in the energy consumption mode.

According to exemplary embodiments of the present invention, when the motor within the vehicle may be used for energy consumption in a non-driven state (e.g., to produce heat), the junction temperature of the switching element in the inverter is decreased, to allow a substantial amount of energy to be consumed compared to a conventional inverter, thereby resulting in a decreased likelihood of damage and improved durability for the inverter. Further, the method of the present invention may be performed by changing a control process for the inverter for controlling the motor. Accordingly, additional cost for additional components may be avoided.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary diagram illustrating an example of the flow of a load current formed in a conventional inverter according to the related art; and

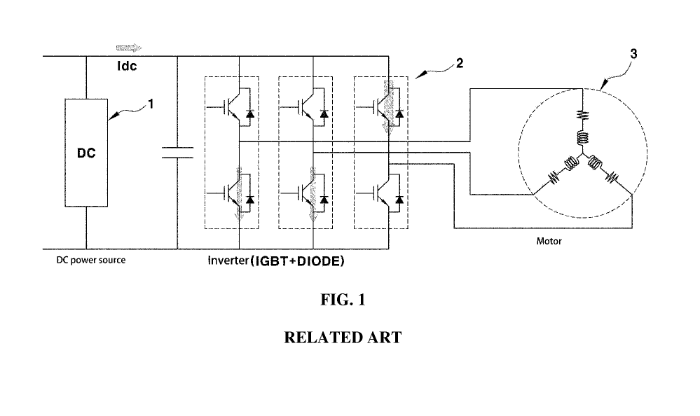

FIG. 2 is an exemplary flowchart illustrating a method for controlling an inverter for operating a motor according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

As described above, when a DC current flows in a stator of a three-phase motor for the purpose of energy consumption, the junction temperature of a predetermined switching element of an associated inverter may rapidly increase, and accordingly, thermal fatigue may accumulate in the predetermined switching element (e.g., an insulated gate bipolar transistor (IGBT)). Potential losses caused by such a problem may include a conduction loss and a switching loss. The following Equation 1 represents an average conduction loss of the IGBT in a triangular wave modulation method, and the following Equation 2 represents an average switching loss of the IGBT.

$$\begin{matrix}{P}_{QON} = {I}_{CP} \cdot {V}_{CE ( sat )} \cdot ( \frac{1}{8} + \frac{m cos θ}{3 π} ) & Equation 1 \\ {P}_{QSWON} = ( {E}_{SWON} + {E}_{SWOFF} ) \cdot {f}_{SW} \cdot \frac{1}{π} & Equation 2\end{matrix}$$

As shown in Equation 1, the conduction loss P_{QON} may be determined based on amplitudes of the voltage V_{CE} and the current I_{CP}, and therefore, reduction of the conduction loss may be difficult. However, as shown in Equation 2, the switching loss P_{QSWON} may be generated in proportion to the switching frequency f_{SW}, and thus the switching loss of the IGBT may be reduced by decreasing the switching frequency of the IGBT, (noting that E_{SWON} and E_{SWOFF} are the energies associated with turning the switches on and off, respectively).

Accordingly, when a DC current is applied to the stator of the motor for the purpose of energy consumption, the junction temperature of the switching element may be lowered by decreasing the switching frequency of the switching element in the inverter for controlling the motor, to reduce likelihood of, or prevent damage to the inverter and to improve the durability of the inverter. Further, it may be possible to safely apply a greater amount of current to the stator of the motor, compared to the amount of current applied before the switching frequency is decreased.

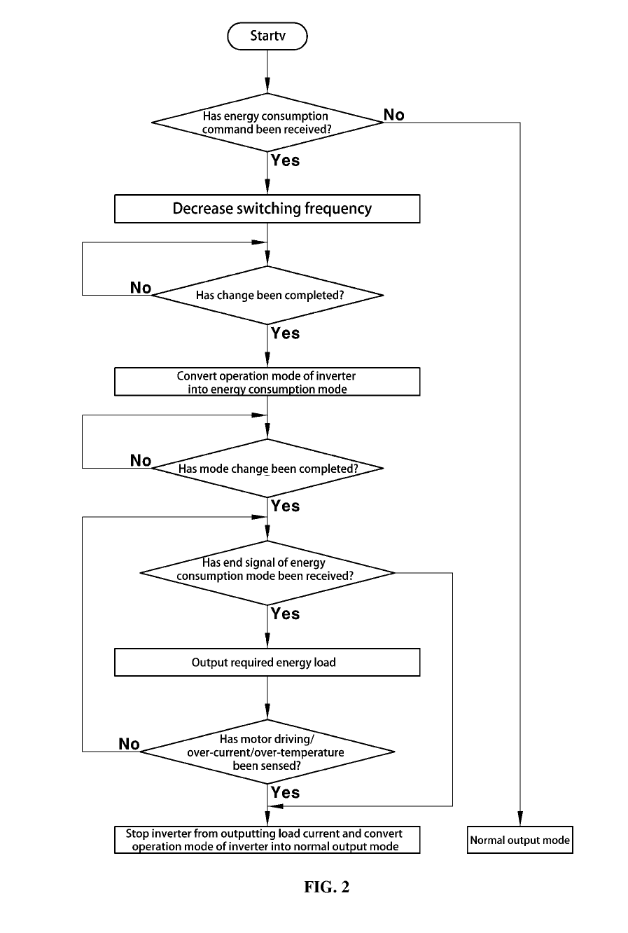

FIG. 2 illustrates an exemplary method for controlling the switching frequency of an inverter according to an operation mode of the inverter. The method may include decreasing, by a controller, a switching frequency of the inverter when the three-phase motor is used for energy consumption. For example, the switching frequency of the inverter may be decreased to a frequency less than a switching frequency of the inverter in a general operation mode. A general operation mode may include a mode of operation resulting from factory presets for an engine control unit (ECU) for the vehicle, or the like. In the method according to the present invention, when the motor is used for energy consumption without being driven, by applying a DC current (load current) to the stator of the motor in a state in which the stator of the motor is fixed, an operation mode of the inverter may be determined based on a command from an upper-level controller (e.g., a second controller), and the switching frequency of the inverter may then be adjusted according to the determined operation mode of the inverter. As shown in FIG. 2, an operation mode of the inverter may be first determined based on a command (e.g., a control signal) received from the upper-level controller.

When the motor is used for energy consumption, the upper-level controller may be configured to transmit a command for operating the inverter in an energy consumption mode (or non-driven output mode). When the motor is used for driving, the upper-level controller may be configured to transmit a command for operating the inverter in a general operation mode (or normal output mode). When the upper-level controller transmits the command for operating the inverter in the normal output mode, a controller (e.g., a first controller) for the inverter may be configured to operate the inverter in the normal output mode to allow the motor to be used for driving of the vehicle. When the upper-level controller transmits the command for operating the inverter in the non-driven output mode, the controller for the inverter may be configured to operate the inverter in the non-driven output mode to allow the motor to be used for the energy consumption. The controller for the inverter may be a lower-level controller operated by the upper-level controller, and the lower-level controller may be configured to operate the inverter, based on at least one command (e.g., a control signal) from the upper-level controller.

When the upper-level controller transmits a command for operating the inverter in the non-driven output mode to allow the motor to be used for the energy consumption, the controller for the inverter may be configured to determine an operation mode for the inverter as a non-driven output mode and then decrease the switching frequency of the inverter t to a frequency lower than a normal operation frequency (e.g., the switching frequency applied in the normal output mode, as discussed above). After the switching frequency of the inverter is decreased, the controller for the inverter may be configured to identify whether a change in frequency has been completed. When the change in frequency is completed, the controller for the inverter may be configured to convert the operation mode of the inverter into the energy consumption mode (e.g., a mode for applying the load current to the motor while maintaining the motor in a non-driven state).

After the operation mode of the inverter is converted into the energy consumption mode, the controller for the inverter may be configured to identify whether the operation mode of the inverter is normally converted into the energy consumption mode, (e.g., whether the inverter enters into the energy consumption mode and normally operates, as described above). Then, the controller for the inverter may be configured to operate the inverter to output the load current to the motor until the upper-level controller receives an operation end signal. In other words, the controller for the inverter may be configured to operate the inverter in the energy consumption mode until the upper-level controller receives an operation end signal.

Accordingly, when operating in the energy consumption mode, the inverter may be configured to apply the load current to the stator of the motor, when the stator of the motor is fixed, until the upper-level controller receives the operation end signal. When the inverter operates in the energy consumption mode to output the load current to the motor, the controller for the inverter may be configured to determine whether the inverter is operating abnormally by repeatedly sensing whether the motor is driven, a current value applied to the motor, and a junction temperature value of the inverter. Abnormal operation of the inverter may include operation at an over temperature or an overcurrent, or the like, (e.g., an over-temperature may be above a safe operating temperature of the inverter or an overcurrent is present, as determined by its manufacturer). In other words, when the inverter operates in the energy consumption mode, the controller for the inverter may be configured to determine whether an abnormality occurs during the operation of the inverter by repeatedly determining whether the motor is driven, determining whether an over-current of a certain value or greater flows in the motor, determining whether the junction temperature of the inverter increases to an over-temperature of a certain value or greater, or the like.

When operating abnormalities occur, including driving of the motor, application of the over-current to the motor, and increase in the junction temperature of the inverter to an over-temperature during the determination processes, the controller for the inverter may be configured to determine an abnormality in the operation of the inverter and stop the inverter from outputting the load current. In other words, when an abnormality occurs in the operation of the inverter in the energy consumption mode, the controller for the inverter may be configured to stop the inverter from outputting the load current and convert the operation mode of the inverter to the general operation mode. In response to receiving the operation end signal from the upper-level controller, the controller for the inverter may also be configured to stop the inverter from outputting the load current and convert the operation mode of the inverter to the general operation mode.

In other words, in response to receiving an operation end signal from the upper-level controller while the inverter is operated in the energy consumption mode, the controller for the inverter may be configured to stop the inverter from outputting the load current and convert the operation mode of the inverter to the general operation mode, even though an abnormality may not be occurring in the operation of the inverter. As an example, the motor, which the inverter operates in the energy consumption mode to apply the load current, may be used for energy consumption to reduce a cold start time of a fuel cell vehicle. In other words, when a fuel cell vehicle starts at a sub-zero temperature, the motor in the vehicle may consume energy to increase the temperature in a fuel cell stack mounted within the vehicle, thus reducing the cold start time of the vehicle.

As another example, the motor which the inverter operates in the energy consumption mode, to apply the load current, may be used as an energy consumption device for rapidly exhausting voltage of a high-voltage terminal before or during a repair of the vehicle or an occurrence of a voltage error, to prevent secondary damage from occurring. When the motor is used for the energy consumption as described above, a load may be concentrated on a predetermined switching element in the inverter. Accordingly, as a result of measuring a junction temperature of the inverter by applying current to the stator of the motor, when the stator of the motor is fixed under a certain condition (e.g., having a fixed current, etc.) but not fixed with respect to the switching frequency of the inverter, the maximum junction temperature may be about 151.5° C. when the switching frequency is about 2*Fbase KHz. In other words, the maximum generated junction temperature may be greater than the safe operating temperature and performance guarantee temperature of the IGBT. Further, the maximum junction temperature may be about 112° C. when the condition of the switching frequency is Fbase KHz. In other words, the maximum junction temperature may be generated within the available temperature and performance guarantee temperature of the IGBT. Accordingly, when the switching frequency is decreased, the junction temperature of the switching element may be decreased.

In addition, when the switching frequency is 2*Fbase KHz, the temperature difference between the maximum junction temperature and the temperature of a coolant may be generated up to about 135°. When the condition of the switching frequency is Fbase KHz, the temperature difference between the maximum junction temperature and the temperature of the coolant may be about 92°. As described above, when a three-phase motor, mounted within a vehicle, is used for energy consumption, the switching frequency of the inverter may be decreased to reduce switching loss of the switching element in the inverter, so that it may be possible to decrease the junction temperature of the switching element and to reduce the thermal fatigue of the switching element, thereby preventing damage and improving durability for the inverter. Further, the junction temperature of the switching element may be decreased compared to that of the conventional inverter, to allow a substantial amount of load current to be applied to the motor, thereby improving energy consumption efficiency.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A method for controlling an inverter, the method comprising:
determining, by a first controller, an operation mode of the inverter, based on a command received from an upper-level controller; and
decreasing, by the first controller, a switching frequency of the inverter to be less than a frequency of the inverter in a general operation mode, when the operation mode of the inverter is determined to be an energy consumption mode.

2. The method of claim 1, further comprising:
converting, by the first controller, the operation mode of the inverter into the energy consumption mode of applying a load current to the motor while maintaining the motor in a non-driven state, in response to the switching frequency of the inverter being decreased.

3. The method of claim 1, further comprising:
operating, by the first controller, the inverter to output the load current to the motor until the upper-level controller receives an end signal, in response the operation mode of the inverter being converted to the energy consumption mode.

4. The method of claim 1, further comprising:
determining, by the first controller, whether an abnormality occurs by determining whether the motor is driven, determining whether an over-current of a certain value or greater flows in the motor, and determining whether the junction temperature of the inverter has increased to at least an over-temperature of a predetermined value in response to the inverter operating in the energy consumption mode.

5. The method of claim 1, further comprising:
stopping, by the first controller, the inverter from outputting the load current, in response to an abnormality occurring in the operation of the inverter in the energy consumption mode; and
converting, by the first controller, the operation mode of the inverter to the general operation mode, in response to an abnormality occurring in the operation of the inverter in the energy consumption mode.

6. The method of claim 1, further comprising:
stopping, by the first controller, the inverter from outputting the load current in response the upper-level controller receiving the end signal in the operation of the inverter in the energy consumption mode,
wherein the operation mode of the inverter is converted to the general operation mode, in response the upper-level controller receiving the end signal in the operation of the inverter in the energy consumption mode.

7. The method of claim 2, further comprising:
operating, by the first controller, the inverter to output the load current to the motor until the upper-level controller receives an end signal, in response the operation mode of the inverter being converted to the energy consumption mode.

8. The method of claim 2, further comprising:
determining, by the first controller, whether an abnormality occurs by determining whether the motor is driven, determining whether an over-current of a certain value or greater flows in the motor, and determining whether the junction temperature of the inverter increases to an over-temperature of a certain value or greater in response to the inverter operating in the energy consumption mode.

9. The method of claim 2, further comprising:
stopping, by the first controller, the inverter from outputting the load current, and the operation mode of the inverter is converted into the general operation mode, in response to an abnormality occurring in the operation of the inverter in the energy consumption mode.

10. The method of claim 2, further comprising:
stopping, by the first controller, the inverter from outputting the load current in response the upper-level controller receiving the end signal in the operation of the inverter in the energy consumption mode; and
converting, by the first controller, the operation mode of the inverter into the general operation mode, in response the upper-level controller receiving the end signal in the operation of the inverter in the energy consumption mode.

11. A non-transitory computer readable medium containing program instructions executed by a processor or controller for controlling a inverter, the computer readable medium comprising:
program instructions that determine an operation mode of the inverter, based on a command received from an upper-level controller; and
program instructions that decrease a switching frequency of the inverter to be less than a frequency of the inverter in a general operation mode, when the operation mode of the inverter is determined to be an energy consumption mode.

12. The non-transitory computer readable medium of claim 11 further comprising:
program instructions that convert the operation mode of the inverter into the energy consumption mode of applying a load current to the motor while maintaining the motor in a non-driven state, in response to the switching frequency of the inverter being decreased.

13. The non-transitory computer readable medium of claim 11, further comprising:
program instructions that operate the inverter to output the load current to the motor until the upper-level controller receives an end signal, in response the operation mode of the inverter being converted to the energy consumption mode.

14. The non-transitory computer readable medium of claim 11, further comprising:
program instructions that determine whether an abnormality occurs by determining whether the motor is driven, determining whether an over-current of a certain value or greater flows in the motor, and determining whether the junction temperature of the inverter has increased to at least an over-temperature of a predetermined value in response to the inverter operating in the energy consumption mode.

15. The non-transitory computer readable medium of claim 11, further comprising:
program instructions that stop the inverter from outputting the load current; in response to an abnormality occurring in the operation of the inverter in the energy consumption mode; and
program instructions that convert the operation mode of the inverter to the general operation mode, in response to an abnormality occurring in the operation of the inverter in the energy consumption mode.

16. The non-transitory computer readable medium of claim 11, further comprising:
program instructions that stop the inverter from outputting the load current in response the upper-level controller receiving the end signal in the operation of the inverter in the energy consumption mode; and
program instructions that convert the operation mode of the inverter to the general operation mode, in response the upper-level controller receiving the end signal in the operation of the inverter in the energy consumption mode.

17. The non-transitory computer readable medium of claim 12, further comprising:
program instructions that operate the inverter to output the load current to the motor until the upper-level controller receives an end signal, in response the operation mode of the inverter being converted to the energy consumption mode.

18. The non-transitory computer readable medium of claim 12, further comprising:
program instructions that determine whether an abnormality occurs through determining whether the motor is driven, determining whether an over-current of a certain value or greater flows in the motor, and determining whether the junction temperature of the inverter increases to an over-temperature of a certain value or greater in response to the inverter operating in the energy consumption mode.

19. The non-transitory computer readable medium of claim 12, further comprising:
program instructions that stop the inverter from outputting the load current, and the operation mode of the inverter is converted into the general operation mode, in response to an abnormality occurring in the operation of the inverter in the energy consumption mode.

20. The non-transitory computer readable medium of claim 12, further comprising:
program instructions that stop the inverter from outputting the load current in response the upper-level controller receiving the end signal in the operation of the inverter in the energy consumption mode; and
program instructions that convert the operation mode of the inverter into the general operation mode, in response the upper-level controller receiving the end signal in the operation of the inverter in the energy consumption mode.
